(19) United States
(12) Patent Application Publication
(10) Pub. No.: US 2014/0207843 A1
(43) Pub. Date: Jul. 24, 2014

(54) DATA PROCESSING METHOD, CONNECTION AUDITING DEVICE, AND SYSTEM

(71) Applicant: Huawei Technologies Co., Ltd., Shenzhen (CN)

(72) Inventors: QIANGMIN LIN, Hangzhou (CN); Jianjun Liu, Shenzhen (CN)

(73) Assignee: Huawei Technologies Co., Ltd., Shenzhen (CN)

(21) Appl. No.: 14/222,964

(22) Filed: Mar. 24, 2014

Related U.S. Application Data
(63) Continuation of application No. PCT/CN2012/082319, filed on Sep. 28, 2012.

(30) Foreign Application Priority Data
Sep. 28, 2011 (CN) 201110301960.8

(51) Int. Cl. H04L 29/08

(52) U.S. Cl. CPC H04L 67/04
USPC 709/202

(57) ABSTRACT

Embodiments of the present invention disclose a data processing method, a connection auditing device, and a system, and relate to the communications field. The data processing method includes: when a terminal connects to a remote virtual desktop, obtaining a capability type of the terminal; obtaining a service data packet, and recognizing a type of the service data packet; when the type of the service data packet matches the capability type of the terminal, sending the service data packet to the terminal; and when the type of the service data packet does not match the capability type of the terminal, sending the service data packet to the remote virtual desktop. In the embodiments of the present invention, service experience of a user is improved during terminal displaying.

### CROSS-REFERENCE TO RELATED APPLICATIONS

This application is a continuation of International Application No. PCT/CN2012/082319, filed on Sep. 28, 2012, which claims priority to Chinese Patent Application No. 201110301960.8, filed on Sep. 28, 2011, both of which are hereby incorporated by reference in their entireties.

### TECHNICAL FIELD

The present invention relates to the communications field, and in particular, to a data processing method, a connection auditing device, and a system.

### BACKGROUND

With the popularization of cloud platforms, users are deploying more and more services to the cloud platforms. After passing connection right verification and validity authentication of a connection auditing device, a client connects to a remote virtual desktop of a cloud platform. After receiving service data packets from a service server, the virtual desktop performs encoding and decoding processing, and transmits, by using a remote desktop protocol, the processed service data packets to a terminal for displaying, as shown in FIG. 1. The virtual desktop is a virtual machine that is virtualized on a physical server by using a virtualization platform. The virtual machine has a complete service processing capability, and provides service processing and a remote virtual desktop office for a customer. The service data packets include a keyboard service data packet, a mouse service data packet, a video service data packet, a voice service data packet and the like.

When the service data packets processed by the virtual desktop are excessively large, some services requiring a high real-time performance cannot be responded to in a timely manner. In the prior art, the remote desktop protocol parses and recognizes the service data packets, and preferentially transmits pre-agreed content, for example, a voice service data packet, so as to achieve preferential processing of a real-time service. Specifically, after receiving all of the processed service data packets from the virtual desktop, the remote desktop protocol recognizes the voice service data packet, and places the voice service data packet at the beginning of a sending queue so as to preferentially transmit the voice service data packet, thereby achieving preferential processing of the real-time service.

During the implementation of the present invention, the inventor finds that the prior art has at least the following disadvantages: In the prior art, the virtual desktop relies entirely on a computing unit of a physical server where the virtual desktop is located to perform the work of encoding and decoding all of the service data packets, so that consumption of the computation capability of a CPU is excessive, which reduces the real-time performance of a service, resulting in degraded service experience of a user during terminal displaying.

### SUMMARY

To improve service experience of a user during terminal displaying, embodiments of the present invention provide a data processing method, a connection auditing device, and a system. The technical solutions are as follows:

A data processing method includes:

when a terminal connects to a remote virtual desktop, obtaining a capability type of the terminal;

obtaining a service data packet, and recognizing a type of the service data packet; and

when the type of the service data packet matches the capability type of the terminal, sending the service data packet to the terminal; and when the type of the service data packet does not match the capability type of the terminal, sending the service data packet to the remote virtual desktop.

A connection auditing device includes:

an obtaining module, configured to: when a terminal connects to a remote virtual desktop, obtain a capability type of the terminal;

an obtaining and recognizing module, configured to obtain a service data packet, and recognize a type of the service data packet; and

a sending module, configured to: when the type of the service data packet matches the capability type of the terminal, send the service data packet to the terminal; and when the type of the service data packet does not match the capability type of the terminal, send the service data packet to the remote virtual desktop.

A data processing system includes a terminal, a physical server, and the connection auditing device, where

the terminal is configured to connect to a remote virtual desktop; and receive a service data packet sent by the connection auditing device; and

the physical server is configured to receive the service data packet sent by the connection auditing device, where the remote virtual desktop is located on the physical server.

The technical solutions provided by the embodiments of the present invention have the following beneficial effects: According to a capability type of a terminal, a service data packet that matches the capability type of the terminal is sent to the terminal for subsequent processing, and a service data packet that does not match the capability type of the terminal is sent to a remote virtual desktop of a cloud platform for subsequent processing. In this way, the amount of service data processed by a physical server where the remote virtual desktop is located is obviously reduced, so that consumption of the computation capability of a CPU is reduced, and the real-time performance of a service is improved accordingly, thereby improving service experience of a user during terminal displaying.

### BRIEF DESCRIPTION OF THE DRAWINGS

To describe the technical solutions according to the embodiments of the present invention more clearly, the following briefly introduces accompanying drawings required for describing the embodiments. Apparently, the accompanying drawings in the following description are only some embodiments of the present invention, and a person of ordinary skill in the art can derive other drawings from the accompanying drawings without creative efforts.

FIG. 1 is a schematic diagram of a network deployment provided by the prior art;

FIG. 2 is a flowchart of an embodiment of a data processing method according to Embodiment 1 of the present invention;

FIG. 3 is a flowchart of an embodiment of a data processing method according to Embodiment 2 of the present invention;

FIG. 4 is a schematic diagram of a network deployment of an embodiment of a data processing method according to Embodiment 2 of the present invention;

FIG. 5 is a first schematic structural diagram of an embodiment of a connection auditing device according to Embodiment 3 of the present invention;

FIG. 6 is a second schematic structural diagram of an embodiment of a connection auditing device according to an embodiment of the present invention; and

FIG. 7 is a schematic structural diagram of an embodiment of a data processing system according to Embodiment 4 of the present invention.

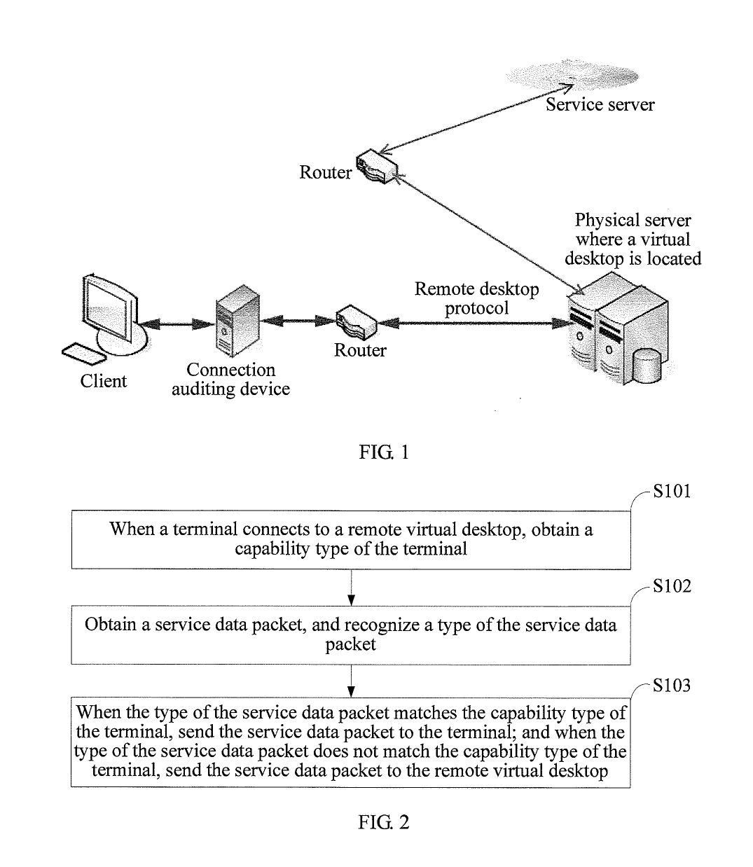

### DETAILED DESCRIPTION

Embodiments of the present invention provide a data processing method, a connection auditing device, and a system.

In order to make the objectives, technical solutions and advantages of the present invention clearer, the following describes the embodiments of the present invention in detail with reference to the accompanying drawings.

### Embodiment 1

Referring to FIG. 2, FIG. 2 is a flowchart of an embodiment of a data processing method according to Embodiment 1 of the present invention. The data processing method includes:

S101: When a terminal connects to a remote virtual desktop, obtain a capability type of the terminal.

S102: Obtain a service data packet, and recognize a type of the service data packet.

S103: When the type of the service data packet matches the capability type of the terminal, send the service data packet to the terminal; and when the type of the service data packet does not match the capability type of the terminal, send the service data packet to the remote virtual desktop.

Further, obtaining a capability type of the terminal includes:

receiving terminal connection information sent by the terminal, and obtaining the capability type of the terminal from the terminal connection information.

Further, the capability type of the terminal includes: having a voice encoding and decoding capability, having a video encoding and decoding capability, or having a Hypertext Markup Language HTML page parsing capability.

Further, obtaining a service data packet includes:

receiving the service data packet sent by a service server.

Further, after the sending the service data packet to the remote virtual desktop, the method further includes:

receiving, by the remote virtual desktop, the service data packet, and performing first processing on the service data packet; and

transmitting, by the remote virtual desktop by using a remote desktop protocol, the service data packet obtained through the first processing to the terminal for displaying.

In this embodiment, according to a capability type of a terminal, a service data packet that matches the capability type of the terminal is sent to the terminal for subsequent processing, and a service data packet that does not match the capability type of the terminal is sent to a remote virtual desktop of a cloud platform for subsequent processing. In this way, the amount of service data processed by a physical server where the remote virtual desktop is located is obviously reduced, so that consumption of the computation capability of a CPU is reduced, and the real-time performance of a service is improved accordingly, thereby improving service experience of a user during terminal displaying.

### Embodiment 2

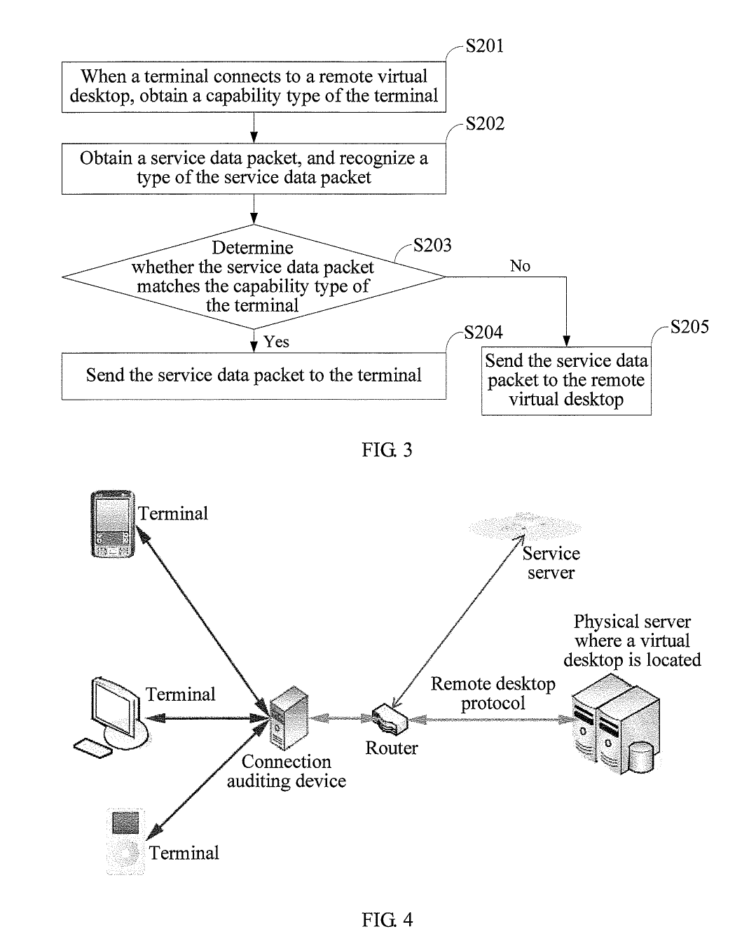

Referring to FIG. 3, FIG. 3 is a flowchart of an embodiment of a data processing method according to Embodiment 2 of the present invention. The data processing method includes:

S201: When a terminal connects to a remote virtual desktop, obtain a capability type of the terminal.

In an actual application, the terminal may be a mobile phone, a PC (Personal Computer, personal computer), a player, or the like, which is not specifically limited in this embodiment.

The remote virtual desktop is a virtual machine that is virtualized on a physical server by using a virtualization platform. The virtual machine has a complete service processing capability, and provides service processing and a remote virtual desktop office for a customer.

When the terminal connects to the remote virtual desktop, a connection auditing device receives terminal connection information sent by the terminal, and performs connection right verification and validity authentication on the terminal according to the terminal connection information, and when the terminal passes the validity authentication, the terminal connects to the remote virtual desktop by using a remote desktop protocol, as shown in FIG. 4. FIG. 4 is a schematic diagram of a network deployment of an embodiment of a data processing method according to Embodiment 2 of the present invention.

The connection auditing device obtains the capability type of the terminal from the terminal connection information. The capability type of the terminal may be at least one of the following: having a voice encoding and decoding capability, having a video encoding and decoding capability, and having a Hypertext Markup Language HTML page parsing capability, to which the capability type of the terminal is not limited, and details are not repeatedly described herein. The capability type of the terminal may be manually configured and added.

In this embodiment, a user may also directly notify the connection auditing device of the capability type of the terminal, so that the connection auditing device obtains the capability type of the terminal.

S202: Obtain a service data packet, and recognize a type of the service data packet.

In this step, after a service server of a cloud platform receives a service request of the terminal or the virtual desktop, the service server sends a service data packet to the connection auditing device according to the service request; and the connection auditing device receives the service data packet sent by the service server, and recognizes a type of the service data packet, where the type of the service data packet includes a voice service, a video service, a mouse service, a keyboard service and other services.

S203: Determine whether the service data packet matches the capability type of the terminal, and if yes, execute S204; if not, execute S205.

In this step, the connection auditing device matches the service data packet with the capability type of the terminal according to the capability type of the terminal, and intelligently determines, according to a matching result, whether to send the service data packet to the terminal or to the remote virtual desktop.

S204: Send the service data packet to the terminal.

Specifically, for example, the type of the service data packet is the voice service, and the capability type of the terminal is having the voice encoding and decoding capability; in this case, the type of the service data packet matches the capability type of the terminal. Accordingly, the service data packet is sent to the terminal, the terminal performs encoding, decoding, and imaging processing on the service data packet, and finally the terminal displays the service data packet to the user.

There may also be multiple capability types of the terminal. For example, the capability types of the terminal are having the voice encoding and decoding capability and having the video encoding and decoding capability. By matching the type of the service data packet, for example, the voice service, with the capability type of the terminal, it is found that the voice service matches the voice encoding and decoding capability. Accordingly, the service data packet corresponding to the voice service is sent to the terminal, the terminal performs encoding, decoding, and imaging processing on the service data packet, and finally the terminal displays the service data packet to the user.

S205: Send the service data packet to the remote virtual desktop.

When the type of the service data packet does not match the capability type of the terminal, the service data packet is sent to the remote virtual desktop. Specifically, for example, the type of the service data packet is the mouse service, and the capability type of the terminal is having the voice encoding and decoding capability. In this case, the type of the service data packet does not match the capability type of the terminal. Accordingly, the service data packet is sent to the remote virtual desktop, and the remote virtual desktop performs first processing on the service data packet, and transmits, by using the remote desktop protocol, the service data packet obtained through the first processing to the terminal for displaying. The first processing is similar to that in the prior art, and details are not repeatedly described herein. For details, reference may be made to relevant description in the prior art.

In this embodiment, a voice software client and video encoding and decoding software may be embedded into the terminal, so that the terminal serves as an SIP (Session Initiation Protocol, session initiation protocol) UE (User Equipment, user equipment) to communicate with an SIP platform by using an SIP/RTP (Real-time Transport Protocol, real-time transport protocol) protocol.

The voice and video services belong to services consuming a large amount of computation, and the keyboard and mouse services belong to services consuming a small amount of computation. In this embodiment, the capability of the terminal is generally for the services consuming a large amount of computation, such as the voice service and the video service, and the services consuming a large amount of computation require a high real-time performance. Compared with the prior art, in this embodiment, the amount of computation of the physical server where the virtual desktop is located is obviously reduced.

In this embodiment, according to a capability type of a terminal, a service data packet that matches the capability type of the terminal is sent to the terminal for subsequent processing, and a service data packet that does not match the capability type of the terminal is sent to a remote virtual desktop for subsequent processing. In this way, the amount of service data processed by a physical server where the remote virtual desktop is located is obviously reduced, so that consumption of the computation capability of a CPU is reduced, and the real-time performance of a service is improved accordingly, thereby improving service experience of a user during terminal displaying.

In addition, in this embodiment, the services consuming a large amount of computation are separated from the remote virtual desktop and processed by the terminal, and the remote virtual desktop only implements light-weight computation tasks, so that not only the capability of the terminal is made full use of, but also the consumption of the computation capability of the physical server where the remote virtual desktop is located is reduced, and the service load of the cloud platform is reduced, thereby improving density of remote virtual desktops of a single server, and reducing a cost. In this embodiment, an intelligent policy is used to determine whether a service needs to be deployed in a bypass manner, so that the service experience of the user is improved by automatically selecting whether to bypass the service.

### Embodiment 3

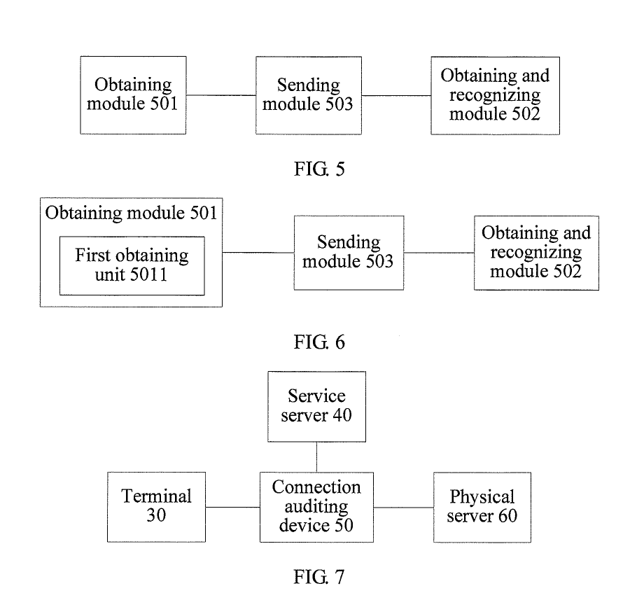

Referring to FIG. 5, FIG. 5 is a first schematic structural diagram of an embodiment of a connection auditing device according to Embodiment 3 of the present invention. The connection auditing device includes:

an obtaining module 501, configured to: when a terminal connects to a remote virtual desktop, obtain a capability type of the terminal;

an obtaining and recognizing module 502, configured to obtain a service data packet, and recognize a type of the service data packet; and

a sending module 503, configured to: when the type of the service data packet matches the capability type of the terminal, send the service data packet to the terminal; and when the type of the service data packet does not match the capability type of the terminal, send the service data packet to the remote virtual desktop.

The obtaining module 501 includes a first obtaining unit 5011, as shown in FIG. 6. FIG. 6 is a second schematic structural diagram of an embodiment of a connection auditing device according to an embodiment of the present invention.

The first obtaining unit 5011 is configured to receive terminal connection information sent by the terminal, and obtain the capability type of the terminal from the terminal connection information.

The obtaining and recognizing module 502 includes:

a receiving unit, configured to receive the service data packet sent by a service server.

In this embodiment, according to a capability type of a terminal, a service data packet that matches the capability type of the terminal is sent to the terminal for subsequent processing, and a service data packet that does not match the capability type of the terminal is sent to a remote virtual desktop for subsequent processing. In this way, the amount of service data processed by a physical server where the remote virtual desktop is located is obviously reduced, so that consumption of the computation capability of a CPU is reduced, and the real-time performance of a service is improved accordingly, thereby improving service experience of a user during terminal displaying.

### Embodiment 4

Referring to FIG. 7, FIG. 7 is a schematic structural diagram of an embodiment of a data processing system according to Embodiment 4 of the present invention. The data processing system includes a connection auditing device 50, a terminal 30, and a physical server 60.

The connection auditing device 50 is configured to: when a terminal connects to a remote virtual desktop, obtain a capability type of the terminal; obtain a service data packet, and recognize a type of the service data packet; and when the type of the service data packet matches the capability type of the terminal, send the service data packet to the terminal; and when the type of the service data packet does not match the capability type of the terminal, send the service data packet to the remote virtual desktop;

Further, the connection auditing device 50 is further configured to receive terminal connection information sent by the terminal, and obtain the capability type of the terminal from the terminal connection information.

Further, the connection auditing device 50 is further configured to receive the service data packet sent by a service server.

The terminal 30 is configured to connect to the remote virtual desktop, and receive the service data packet sent by the connection auditing device; and

The physical server 60 is configured to receive the service data packet sent by the connection auditing device, where the remote virtual desktop is located on the physical server.

Further, the physical server 60 is further configured to perform first processing on the service data packet; and transmit, by using a remote desktop protocol, the service data packet obtained through the first processing to the terminal for displaying.

Further, the terminal 30 is further configured to send the terminal connection information to the connection auditing device; and receive and display the service data packet obtained through the first processing and transmitted by the physical server.

Further, the data processing system further includes:

a service server 40, configured to send the service data packet to the connection auditing device.

In this embodiment, according to a capability type of a terminal, a service data packet that matches the capability type of the terminal is sent to the terminal for subsequent processing, and a service data packet that does not match the capability type of the terminal is sent to a remote virtual desktop for subsequent processing. In this way, the amount of service data processed by a physical server where the remote virtual desktop is located is obviously reduced, so that consumption of the computation capability of a CPU is reduced, and the real-time performance of a service is improved accordingly, thereby improving service experience of a user during terminal displaying.

In addition, in this embodiment, the services consuming a large amount of computation are separated from the remote virtual desktop, and the remote virtual desktop implements only light-weight computation tasks, so that the consumption of the computation capability of the physical server where the remote virtual desktop is located is reduced, thereby improving density of remote virtual desktops of a single server. In this embodiment, an intelligent policy is used to determine whether a service needs to be deployed in a bypass manner, so that the service experience of the user is improved by automatically selecting whether to bypass the service.

It should be noted that, the embodiments in this specification are described in a progressive manner, and the focus of the description in each embodiment is a difference from another embodiment. For the identical or similar parts of the embodiments, reference may be made to each other. The apparatus embodiments are basically similar to the method embodiments, and therefore are described briefly. For relevant parts, reference may be made to part of the description in the method embodiments.

It should be noted that in the specification, relational terms such as first and second are used only to differentiate an entity or operation from another entity or operation, and do not require or imply that any actual relationship or sequence exists between these entities or operations. Moreover, the terms “include”, “comprise”, or any variant thereof is intended to cover a non-exclusive inclusion. Therefore, a process, a method, an article, or a device that includes a list of elements not only includes those elements but also includes other elements which are not expressly listed, or further includes elements inherent to such process, method, article, or device. An element preceded by “includes a . . . ” does not, without more constraints, preclude the existence of additional identical elements in the process, method, article, or apparatus that includes the element.

A person of ordinary skill in the art may understand that all or a part of the steps of the foregoing embodiments may be implemented by hardware, and may also be implemented by program instructing relevant hardware. The program may be stored in a computer readable storage medium. The storage medium may be a read-only memory, a magnetic disk, an optical disc or the like.

The foregoing descriptions are merely exemplary embodiments of the present invention, but are not intended to limit the present invention. Any modification, equivalent replacement, or improvement made without departing from the spirit and principle of the present invention shall fall within the protection scope of the present invention.

What is claimed is:

1. A data processing method, comprising:
when a terminal connects to a remote virtual desktop, obtaining a capability type of the terminal;
obtaining a service data packet, and recognizing a type of the service data packet; and
when the type of the service data packet matches the capability type of the terminal, sending the service data packet to the terminal, and when the type of the service data packet does not match the capability type of the terminal, sending the service data packet to the remote virtual desktop.

2. The method according to claim 1, wherein obtaining a capability type of the terminal comprises:
receiving terminal connection information sent by the terminal, and obtaining the capability type of the terminal from the terminal connection information.

3. The method according to claim 1, wherein the capability type of the terminal is at least one of the following: having a voice encoding and decoding capability, having a video encoding and decoding capability, and having a Hypertext Markup Language HTML page parsing capability.

4. The method according to claim 1, wherein obtaining a service data packet comprises:
receiving the service data packet sent by a service server.

5. The method according to claim 1, wherein after sending the service data packet to the remote virtual desktop, the method further comprises:
receiving, by the remote virtual desktop, the service data packet, and performing first processing on the service data packet; and
transmitting, by the remote virtual desktop by using a remote desktop protocol, the service data packet obtained through the first processing to the terminal for displaying.

6. A connection auditing device, comprising:
an obtaining module, configured to: when a terminal connects to a remote virtual desktop, obtain a capability type of the terminal;
an obtaining and recognizing module, configured to obtain a service data packet, and recognize a type of the service data packet; and
a sending module, configured to: when the type of the service data packet matches the capability type of the terminal, send the service data packet to the terminal; and when the type of the service data packet does not match the capability type of the terminal, send the service data packet to the remote virtual desktop.

7. The device according to claim 6, wherein the obtaining module comprises:
a first obtaining unit, configured to receive terminal connection information sent by the terminal and obtain the capability type of the terminal from the terminal connection information.

8. The device according to claim 7, wherein the obtaining and recognizing module comprises:
a receiving unit, configured to receive the service data packet sent by a service server.

9. A data processing system, comprising:
a terminal, a physical server, and a connection auditing device, wherein:
the terminal is configured to connect to a remote virtual desktop; and receive a service data packet sent by the connection auditing device;
the physical server is configured to receive the service data packet sent by the connection auditing device;
the remote virtual desktop is located on the physical server; and
the connection auditing device comprises:
an obtaining module, configured to: when a terminal connects to a remote virtual desktop, obtain a capability type of the terminal,
an obtaining and recognizing module, configured to obtain a service data packet, and recognize a type of the service data packet, and
a sending module, configured to: when the type of the service data packet matches the capability type of the terminal, send the service data packet to the terminal; and when the type of the service data packet does not match the capability type of the terminal, send the service data packet to the remote virtual desktop.

10. The system according to claim 9, wherein the physical server is further configured to:
perform first processing on the service data packet; and
transmit, by using a remote desktop protocol, the service data packet obtained through the first processing to the terminal for displaying.

11. The system according to claim 10, wherein the terminal is further configured to:
send terminal connection information to the connection auditing device; and
receive and display the service data packet obtained through the first processing and transmitted by the physical server.

12. The system according to claim 9, further comprising:
a service server, configured to send the service data packet to the connection auditing device.
